(19) United States
(12) Patent Application Publication
(10) Pub. No.: US 2014/0078632 A1
(43) Pub. Date: Mar. 20, 2014

(54) BATTERY PACK, CONTROLLING METHOD OF THE SAME, AND ENERGY STORAGE SYSTEM INCLUDING THE BATTERY PACK

(71) Applicant: Samsung SDI Co., Ltd., Yongin-si (KR)

(72) Inventor: Yeon-Sung Jung, Yongin-si (KR)

(73) Assignee: Samsung SDI Co., Ltd., Yongin-si (KR)

(21) Appl. No.: 13/953,591

(22) Filed: Jul. 29, 2013

Related U.S. Application Data
(60) Provisional application No. 61/702,575, filed on Sep. 18, 2012.

(51) Int. Cl. H02H 3/08

(52) U.S. Cl. CPC H02H 3/08
USPC 361/87; 361/104

(57) ABSTRACT

A battery protection apparatus is disclosed. In one aspect, the apparatus includes a temperature-dependent resistor electrically connected to at least one battery cell, wherein the temperature-dependent resistor is configured to change internal resistance in a substantially inversely proportional relationship to temperature of one or more of the at least one battery cell. The apparatus further includes a battery protection unit connected between the temperature-dependent resistor and the at least one battery cell, wherein the battery protection unit is configured to block the current flowing through one or more of the at least one battery cell when the current exceeds a first reference value.

### RELATED APPLICATION

This application claims priority to and the benefit of Provisional Patent Application No. 61/702,575 filed on Sep. 18, 2012 in the U.S. Patent and Trademark Office, the entire contents of which are incorporated herein by reference.

### BACKGROUND

1. Field

The described technology generally relates to a battery pack, a controlling method of the same, and an energy storage system including the battery pack.

2. Description of the Related Technology

As problems related to environmental destruction and natural resource depletion have arisen, systems for storing power and efficiently utilizing stored power are undergoing active research. Furthermore, renewable energies that are generated without producing significant environmental pollution are the subject of active commercial development. An energy storage system that interconnects such renewable energies, batteries storing power, and existing grid power to one another and is also the subject of research and development efforts.

In such an energy storage system, efficient management of a battery is one of the most important factors. Secondary (rechargeable) batteries are generally managed by taking into consideration various factors such as charging, discharging and prevention of overheating. Efficient management of a battery generally increases the lifespan of the battery and enables the battery to supply stable power to a load.

### SUMMARY

One inventive aspect is an energy storage system including a battery pack, in which a fuse is cut when a battery is overheated.

Another aspect is a battery protection apparatus, comprising: a temperature-dependent resistor electrically connected to at least one battery cell, wherein the temperature-dependent resistor is configured to change internal resistance in a substantially inversely proportional relationship to temperature of one or more of the at least one battery cell; and a battery protection unit connected between the temperature-dependent resistor and the at least one battery cell, wherein the battery protection unit is configured to block the current flowing through one or more of the at least one battery cell when the current exceeds a first reference value.

In the above apparatus, the temperature-dependent resistor is a negative temperature coefficient (NTC) thermistor configured to decrease internal resistance when the battery temperature increases. In the above apparatus, the battery protection unit comprises a fuse.

In the above apparatus, the battery protection unit is a single battery protection unit, wherein the temperature-dependent resistor is a single temperature-dependent resistor, and wherein the at least one battery cell comprises a plurality of battery cells connected to the single battery protection unit and the single temperature-dependent resistor.

In the above apparatus, the battery cells comprise n battery cells connected in series, wherein n is a positive integer and greater than 1, wherein the battery protection unit is connected to the first of the n battery cells, wherein the temperature-dependent resistor is connected to the nth battery cell, and wherein the battery cells are configured to form a closed-loop with the battery protection unit and the temperature-dependent resistor. In the above apparatus, the battery protection unit comprises a plurality of battery protection units, wherein the temperature-dependent resistor comprises a plurality of temperature-dependent resistors, and wherein the at least one battery cell comprises a plurality of battery cells electrically connected to the battery protection units and the temperature-dependent resistors.

In the above apparatus, each of the battery cells comprises first and second terminals, wherein each of the battery protection units is connected to the first terminal of at least one of the battery cells, wherein each of the temperature-dependent resistors is connected to the second terminal of at least one of the battery cells, and wherein at least one of the battery cells is configured to form a closed-loop with at least one of the battery protection units and at least one of the temperature-dependent resistors.

The above apparatus further comprises at least one resistor connected in series with the temperature-dependent resistor. The above apparatus further comprises a battery management system (BMS) electrically connected to the at least one battery cell. The above apparatus further comprises a current fuse electrically connected to the battery protection unit and the BMS, wherein the BMS is configured to detect the temperature of the at least one battery cell and blow the current fuse when the detected temperature exceeds a second reference value. In the above apparatus, the battery protection unit is configured to block the current regardless of whether the BMS operates normally or not. In the above apparatus, the battery protection unit is configured to block the current without separately monitoring temperature of the at least one battery cell.

Another aspect is a battery protection apparatus, comprising: a temperature-dependent resistor electrically connected to one end of a plurality of battery cells, wherein the temperature-dependent resistor is configured to change internal resistance based at least in part on temperature of at least one of the battery cells; a battery protection unit connected between the temperature-dependent resistor and another opposing end of the battery cells, wherein the battery protection unit is configured to block the current flowing through the battery cells when the current exceeds a reference value, and wherein the temperature-dependent resistor and the battery protection unit are electrically connected to each other without having a resistor connected in parallel.

In the above apparatus, the temperature-dependent resistor is a negative temperature coefficient (NTC) thermistor configured to decrease internal resistance when the battery temperature increases. In the above apparatus, the battery protection unit is an electrical fuse configured to be blown when current applied thereto exceeds the reference value. The above apparatus further comprises a battery management system (BMS) electrically connected to the battery cells

Another aspect is an energy storage system, comprising: a plurality of batteries a fuse located adjacent to the batteries; a plurality of external terminals configured to be connected to a load; an NTC thermistor electrically connected to at least one of the batteries; and a resistor connected in series with the NTC thermistor, wherein the batteries, the fuse and the external terminals form a main current path, and wherein at least one of the batteries, the fuse, the resistor and the NTC thermistor form a battery protection path.

In the above system, the fuse comprises a plurality of fuses, wherein the NTC thermistor comprises a plurality of NTC thermistors, and wherein the batteries are electrically connected to the fuses and the NTC thermistors. In the above apparatus, each of the batteries comprises first and second terminals, wherein each of the fuses is connected to the first terminal of at least one of the batteries, wherein each of the NTC thermistors is connected to the second terminal of at least one of the batteries, and wherein at least one of the batteries is configured to form a closed-loop with at least one of the fuses and at least one of the NTC thermistors. The above apparatus further comprises a battery management system (BMS) electrically connected to the batteries, wherein the fuse, the NTC thermistor and the resistor are separated from the BMS.

### BRIEF DESCRIPTION OF THE DRAWINGS

FIG. 1 illustrates an energy storage system according to an embodiment.

FIG. 2 illustrates a battery and a battery management system (BMS).

FIG. 3 illustrates a battery pack including a battery and a protection circuit according to an embodiment.

FIG. 4 illustrates a battery pack including a battery and a protection circuit according to another embodiment.

FIG. 5 is a flowchart showing an operation of a battery pack including a battery and a protection circuit according to an embodiment.

### DETAILED DESCRIPTION

Embodiments will now be described more fully with reference to the accompanying drawings. The invention may, however, be embodied in many different forms and should not be construed as being limited to the embodiments set forth herein. Like numbers refer to like elements throughout.

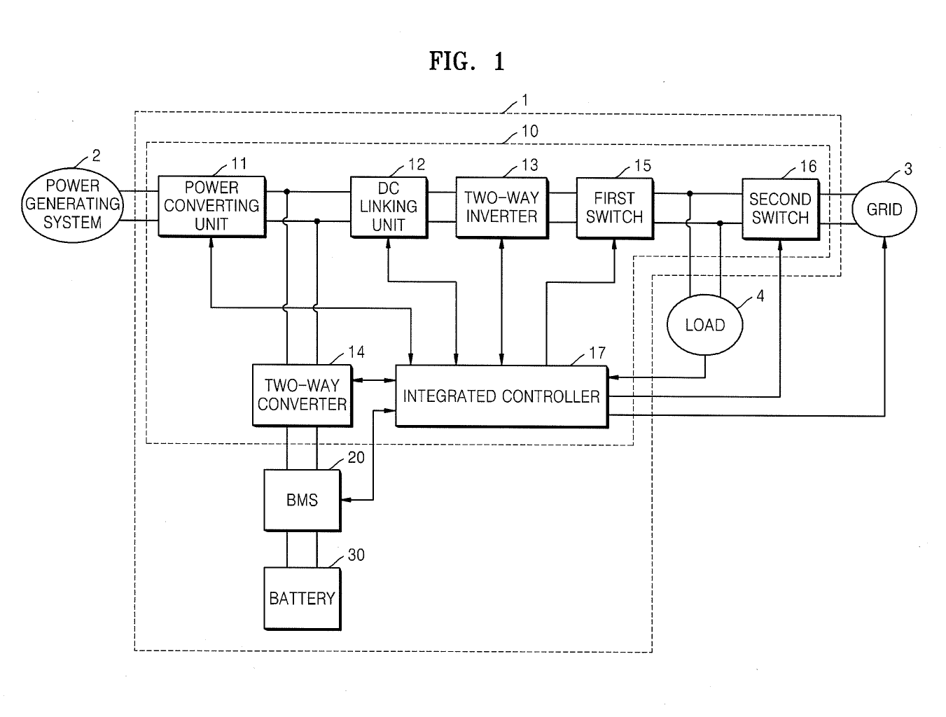

FIG. 1 illustrates an energy storage system 1 according to an embodiment. Referring to FIG. 1, the power storage system 1 works with a power generating system 2 and a grid 3 and supplies power to a load 4.

The power generating system 2 generates power by using an energy source and supplies the generated power to the energy storage system 1. The power generating system 2 may include any of various power generating systems for generating power by using renewable energy, e.g., a solar power generating system, a wind power generating system, a tidal power generating system, etc.

The grid 3 includes a power plant, a substation, and a power line. The grid 3 applies power to the energy storage system 1, such that power is supplied to the load 4 and/or a battery 30. Alternatively, the grid 3 receives power from the energy storage system 1.

The load 4 consumes power generated by the power generating system 2, power stored in the battery 30, or power supplied from the grid 3 and may be a household or a factory, for example.

The energy storage system 1 may store power generated by the power generating system 2 in the battery 30 and supply the generated power to the grid 3. Furthermore, the energy storage system 1 may supply power stored in the battery 30 to the grid 3 or store power supplied by the grid 3 in the battery 30. Furthermore, if power is interrupted at the grid 3, the energy storage system 1 functions as an uninterruptible power supply (UPS).

The energy storage system 1 includes a power conversion system (PCS) 10, a battery management system (BMS) 20, the battery 30, and a manual switch 40. Depending on the implementation, certain elements/blocks may be removed from or additional elements/blocks may be added to the energy storage system 1 illustrated in FIG. 1. Furthermore, two or more elements/blocks may be combined into a single element/block, or a single element/block may be realized as multiple elements/blocks.

The PCS 10 converts power from the power generating system 2, the grid 3, or the battery 30 to appropriate power and supplies the converted power to a power-demanding load. The PCS 10 includes a power converting unit 11, a direct current (DC) linking unit 12, a two-way inverter 13, a two-way converter 14, a first switch 15, a second switch 16, and an integrated controller 17.

The power converting unit 11 is connected between the power generating system 2 and the DC linking unit 12. The power converting unit 11 transmits power generated by the power generating system 2 to the DC linking unit 12, where the output voltage is converted to a DC link voltage.

The power converting unit 11 may include a converter or a rectifying circuit, according to the type of the power generating system 2. If the power generating system 2 generates DC power, the power converting unit 11 may be a converter for converting DC power to AC power. If the power generating system 2 generates AC power, the power converting unit 11 may be a converter circuit such as a rectifying circuit for converting AC power to DC power. If the power generating system 2 generates power from solar energy, the power converting unit 11 may include a maximum power point tracking (MPPT) converter which performs MPPT controls for the power generating system 2 to generate the maximum power based on changes of solar radiation and temperature.

The DC linking unit 12 is connected between the power converting unit 11 and the two-way inverter 13. The DC linking unit 12 prevents momentary voltage drops of the power generating system 2 or the grid 3 and peak load at the load 4, thereby maintaining DC link voltage stable.

The two-way inverter 13 is a power inverter connected between the DC linking unit 12 and the first switch 15. The two-way inverter 13 inverts a DC link voltage output by the power generating system 2 and/or the battery 30 to AC voltage for the grid 3 and outputs the AC voltage in discharging mode. Furthermore, to store power from the grid 3 in the battery 30 in charging mode, the two-way inverter 13 rectifies AC voltage of the grid 3, converts the rectified AC voltage to DC link voltage, and outputs the converted DC link voltage.

The two-way inverter 13 may include a filter for removing harmonics from AC voltage output to the grid 3 and a phase-locked loop (PLL) circuit for synchronizing phase of output AC voltage to phase of AC voltage of the grid 3. Furthermore, the two-way inverter 13 may perform functions including restriction of a range of voltage changes, phase compensation, DC ingredient removal, transient phenomena protection, etc.

The two-way converter 14 DC-DC converts power stored in the battery 30 to a voltage level demanded by the two-way inverter 13, that is, to DC link voltage and outputs the converted DC link voltage in discharging mode. Furthermore, in charging mode, the two-way converter 14 DC-DC converts power output by the power converting unit 11 or power output by the two-way inverter 13 to a voltage level demanded by the battery 30, that is, charging voltage.

The first switch 15 and the second switch 16 are connected in series between the two-way inverter 13 and the grid 3 and controls flow of a current between the power generating system 2 and the grid 3 by being turned on and off under the control of the integrated controller 17. The first and second switches 15 and 16 may be turned on or off based on states of at least one of the power generating system 2, the grid 3, and the battery 30. For example, if the load 4 demands a large amount of power, both of the switches 15 and 16 are turned on, such that power from both the power generating system 2 and the grid 3 may be used. In some embodiments, if power from the power generating system 2 and the grid 3 is insufficient to satisfy power demanded by the load 4, power stored in the battery 30 may be provided to the load 4. In another embodiment, if power is interrupted at the grid 3, the second switch 16 is turned off and the first switch 15 is turned on. Therefore, power from the power generating system 2 or the battery 30 may be supplied to the load 4 and prevent power supplied to the load 4 from flowing to the grid 3. In other words, islanding may be prevented, and thus accidents including electrification of a worker working on a power line of the grid 3 may be prevented.

The integrated controller 17 monitors states of the power generating system 2, the grid 3, the battery 30, and the load 4 and controls the power converting unit 11, the two-way inverter 13, the two-way converter 14, the first switch 15, the second switch 16, and the BMS 20 based on a result of the monitoring. The integrated controller 17 may monitor various facts, such as whether power is interrupted at the grid 3 and whether power is generated by the power generating system 2. Furthermore, the integrated controller 17 may monitor the amount of power generated by the power generating system 2, charging state of the battery 30, the amount of power consumed by the load 4, time, etc.

In some embodiments, the BMS 20 is connected to the battery 30 and controls charging and discharging of the battery 30 under the control of the integrated controller 17. The BMS 20 may perform functions including, but not limited to, overcharging protection, over-discharging protection, overcurrent protection, overvoltage protection, and overheat protection to protect the battery 30. To this end, the BMS 20 may monitor at least one of voltage, current, temperature, remaining power, lifespan, and charging state of the battery 30 and transmit a result of the monitoring to the integrated controller 17.

The battery 30 receives and stores power generated by the power generating system 2 or power from the grid 3 and supplies stored power to the load 4 or the grid 3. The battery 30 may include at least one battery racks connected in series and/or in parallel. Here, the battery rack is a sub-component constituting the battery 30. Furthermore, each of the battery rack may include at least one battery trays connected in series and/or in parallel.

Here, the battery tray is a sub-component constituting the battery rack. Furthermore, each of the battery trays may include a plurality of battery cells. The battery 30 may be embodied of any of various types of battery cells. For example, the battery 30 may be a nickel-cadmium battery, a lead storage battery, a nickel metal hydride (NiMH) battery, a lithium ion battery, a lithium polymer battery, etc.

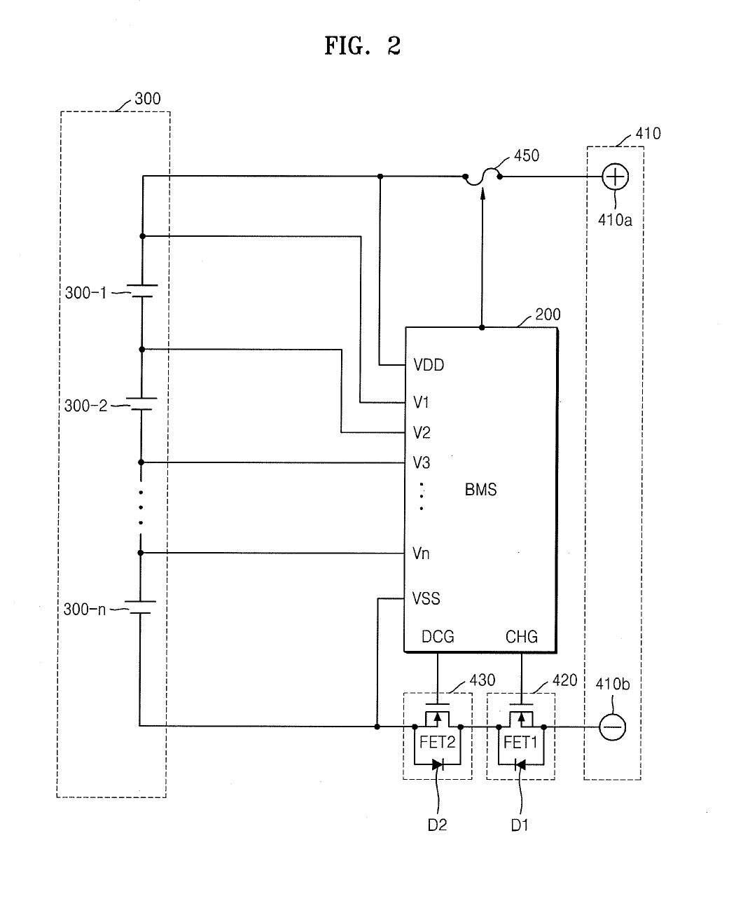

FIG. 2 illustrates a battery 300 and a BMS 200.

FIG. 2 shows a circuit including the BMS 200, the battery 300, a terminal unit 410, charging/discharging control switches 420 and 430, and a high current fuse 450.

The battery 300 may include one or more battery cells 300-1 through 300-n . As described above, the battery 300 receives and stores power from external sources or supplies power to an external system or a load. As described above, the BMS 200 controls states of the battery 300. The terminal unit 410 includes at least a positive electrode terminal 410a and a negative electrode terminal 410b. Power stored in the battery 300 may be supplied to an external system or a load via the terminal unit 410. Furthermore, external power may be supplied to the battery 300 via the terminal unit 410 and charge the battery 300. When the battery 300 is used in a mobile device, the terminal unit 410 may be connected to the mobile device or a charger. Alternatively, if the battery 300 is used in the energy storage system 1, the terminal unit 410 may be connected to the two-way converter 14

Furthermore, the charging control switch 420 or the discharging control switch 430 receives a charging control signal or a discharging control signal from the BMS 200 and blocks or connects charging/discharging path of the battery 300.

In some embodiments, to protect the battery 300, the high current fuse 440 receives a signal from the BMS and blocks a high current path. For example, the BMS 200 may cut the high current fuse 440 if the battery 300 may be overheated. The high current fuse 450 may be replaced with the charging control switch 420 and the discharging control switch 430.

When the battery 300 is overheated in the FIG. 2 battery pack, the BMS 200 detects temperature of the battery 300 and cuts the high current fuse 450 to protect the battery 300. In other words, the BMS 200 continuously monitors temperature of the battery 300. As shown in FIG. 2, the BMS 200 may receive values of temperature of the battery 300 via terminals V1, V2, . . . , and Vn. To this end, the BMS 200 may include a thermistor therein.

A thermistor is a type of resistor and is an electric device using the principle that resistance of a material is changed according to temperature. The thermistor is also referred to as a thermally-varying resistor and is used for preventing a current of a circuit from exceeding a predetermined level or as a sensor for detecting temperature of a circuit.

A thermistor is generally formed of a polymer or a ceramic material and is capable of detecting a temperature between about −90° C. and about 130° C. at high precision. It is the difference between a thermistor and a resistance thermometer which detects high temperature by using a pure metal.

Thermistors may be categorized into two types according to degrees of temperature changes with respect to changes of temperatures. If resistance of a thermistor increases according to temperature, the thermistor is referred to as a positive temperature coefficient (PTC) thermistor. If resistance of a thermistor decreases when temperature increases, the thermistor is referred to as a negative temperature coefficient (NTC) thermistor. A general resistor, which is not a thermistor, is adjusted to exhibit little resistance changes according to temperatures.

The BMS 200 detects temperature of the battery 300 based on a PTC thermistor or an NTC thermistor and blocks power supplied to the battery 300 or power supplied by the battery 300 by transmitting a signal to the high current fuse 440 if the battery 300 is being overheated.

However, when the BMS 200 detects temperature of the battery 300 and cuts the high current fuse 440, if the BMS 200 stops operation, the battery 300 cannot be protected even if the battery 300 is overheated. The BMS 200 may not operate normally due to deterioration or malfunction.

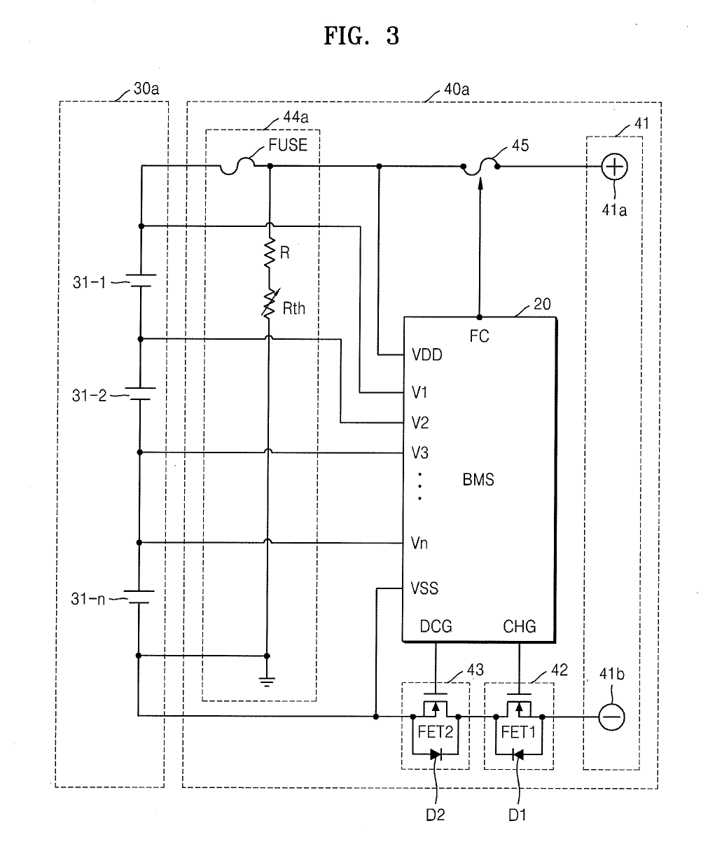

FIG. 3 illustrates a battery pack including a battery and a protection circuit according to an embodiment. Hereinafter, a combination of the battery 30a and the protection circuit 40a controlling the same will be referred to as a battery pack. Referring to FIG. 3, the battery pack according to the present embodiment includes the battery 30a and the protection circuit 40a including BMS 20. The battery 30a may include one or more battery cells 31-1 through 31-n. The battery 30a is connected to the protection circuit 40a, so that the battery 30a may supply power to an external system or a load or receive external power.

Meanwhile, if the battery 30a is used in the energy storage system 1, the reference numerals 31-1 through 31-n shown in FIG. 3 may denote individual battery racks or battery trays constituting the battery 30a. Description will be given below under an assumption that the reference numerals 31-1 through 31-n denote a plurality of battery cells. However, the descriptions below may also be applied even when the reference numerals 31-1 through 31-n denote a plurality of battery trays or a plurality of battery racks.

The protection circuit 40a controls charging and discharging of the battery 30a and controls components in a battery pack for stable operation. The protection circuit 40a may include a terminal unit 41, a BMS 20, a charging control switch 42, a discharging control switch 43, a resistor unit 44a, and a high current fuse 45.

The terminal unit 41 includes at least a positive electrode terminal 41a and a negative electrode terminal 41b. Power stored in the battery 30a may be supplied to an external system or a load via the terminal unit 41. Furthermore, external power may be supplied to the battery 30a via the terminal unit 41 to charge the battery 30a. If the battery 30a is used in a mobile device, the terminal unit 41 may be connected to the mobile device or a charger. Alternatively, if the battery 30a is used in the energy storage system 1, the terminal unit 41 may be electrically connected to the two-way converter 14 for power conversion.

The BMS 20 monitors charging or discharge status of the battery 30a, current flow in a battery pack, etc., and performs charging control or discharging control. The BMS 20 may include a power terminal VDD, a ground terminal VSS, a charging control terminal CHG, a discharging control terminal DCG, at least one voltage detecting terminals V1 through Vn, and a fuse control terminal FC.

Power voltage and ground voltage are applied to the power terminal VDD and the ground terminal VSS, respectively. When there is a problem in the battery 30a, the charging control terminal CHG or the discharging control terminal DCG output a charging control signal for controlling operation of the charging control switch 42 or a discharging control signal for controlling operation of the discharging control switch 43. Furthermore, if the battery 30a may be overheated, the fuse control terminal FC outputs a fuse control signal for controlling the high current fuse 45.

In some embodiments, at least one of the voltage detecting terminals V1 through Vn measures intermediate voltage of the battery 30a. In other words, the voltage detecting terminals V1 through Vn are electrically connected to a node between the battery cells 31-1 through 31-n and measure voltages of the battery cells 31-1 through 31-n.

Each of the charging control switch 42 and the discharging control switch 43 may include a field effect transistor FET and a parasitic diode. For example, the charging control switch 42 includes a field effect transistor FET1 and a parasitic diode D1, whereas the discharging control switch 43 includes a field effect transistor FET2 and a parasitic diode D2. A connecting direction between a source and a drain of the field effect transistor FET1 of the charging control switch 42 is set to be opposite as compared to the field effect transistor FET2 of the discharging control switch 43. Here, the field effect transistors FET1 and FET2 of the charging control switch 42 and the discharging control switch 43 are switching devices. However, the present invention is not limited thereto, and any of various other types of electric switching devices may be used. For example, if the battery 30a is used in the energy storage system 1, since a current flowing on a high current path is very large, a relay may be used. The switching devices may also include bipolar transistors, other digital or analog switches.

The resistor unit 44a includes a fuse FUSE, a resistor R, and a thermistor resistor Rth. Instead of or in addition to the fuse FUSE, the resistor unit 44a may include other battery protection unit such as a circuit breaker. The thermistor resistor Rth may be located in adjacent or contact to the battery 30a to detect temperature. The thermistor resistor Rth included in the resistor unit 44a may be an NTC thermistor. Furthermore, if a current exceeding a reference value flows, the fuse FUSE may insulate two opposite ends thereof.

Referring to FIG. 3, the resistor unit 44a may form a closed-loop with the battery 30a. In some embodiments, the battery 30a, the fuse FUSE and terminals 41a and 41b form a main current path whereas the battery 30a and the resistor unit 44a form a battery protection path.

In one embodiment, if the battery 30a is overheated, since the thermistor resistor Rth is an NTC thermistor, the resistance of the thermistor resistor Rth decreases. When the resistor unit 44a forms a closed-loop with the battery 30a, current flowing in the fuse FUSE is inversely proportional to resistance of a resistor device. For example, the smaller the sum of resistances of the resistor R and the thermistor resistor Rth, the larger the current flowing in the fuse FUSE.

Therefore, if the battery 30a is overheated, the resistance of the thermistor resistor Rth, which is an NTC thermistor, decreases, and thus a current exceeding a reference value flows in the fuse FUSE. The fuse FUSE may block a high current path via which the battery 30a exchanges power with an external device.

In some embodiments, even if the BMS 20 does not monitor the state of the battery 30a and transmit a signal to the high current fuse 45, overheating of the battery 30a may be automatically detected and the fuse FUSE may block a high current path via which the battery 30a exchanges power with an external device. That is, regardless of whether the BMS 20 operates normally or not, the battery 30a can be protected from a high current. Of course, while the BMS 20 is normally operating, the BMS 20 may transmit a signal to the high current fuse 45 to block the high current path.

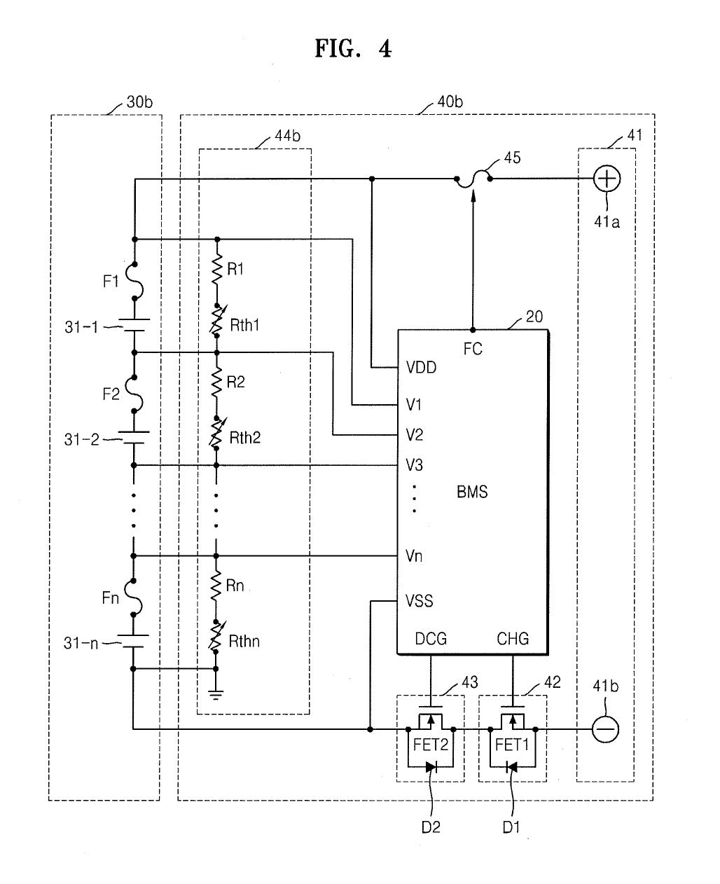

FIG. 4 illustrates a battery pack including a battery and a protection circuit according to another embodiment. Since the embodiment shown in FIG. 4 is a modification of the FIG. 3 embodiment, any repeated description will be omitted and only distinguishing features of the FIG. 4 embodiment will be described below.

Referring to FIG. 4, a battery pack according to the present embodiment includes the battery 30b and the protection circuit 40b. The battery 30b may include one or more battery cells 31-1 through 31-n. wherein the batteries, the fuse and the external terminals form a main current path, and wherein at least one of the batteries 31-1 to 31-n, at least one of the fuses F1 to Fn, at least one of the resistors R1 to Rn and at least one of the NTC thermistors Rth1 to Rthn form a battery protection path.

Same as in the previous embodiment, the battery 30b is connected to the protection circuit 40b and may either supply power to an external system or a load or receive external power. Furthermore, first through n^{th} fuses F1 through Fn are respectively connected in series to the battery cells 31-1 through 31-n in the battery 30b.

The protection circuit 40b controls charging and discharging of the battery 30b and controls components in a battery pack for stable operation. Same as in the previous embodiment, the protection circuit 40b may include the terminal unit 41, the BMS 20, the charging control switch 42, the discharging control switch 43, a resistor unit 44b, and the high current fuse 45.

In the present embodiment, the resistor unit 44b includes first through n^{th} resistors and first through n^{th} thermistor resistors Rth1 through Rthn. The first through n^{th} thermistors Rth1 through Rthn included in the resistor unit 44b may be NTC thermistors.

In some embodiments, the resistances of the first through n^{th} thermistor resistors Rth1 through Rthn respectively connected to the battery cells 31-1 through 31-n are changed according to temperatures of the battery cells 31-1 through 31-n and change currents flowing in the first through n^{th} fuses F1 through Fn. In this embodiment, when currents exceeding a reference value flowing in the first through n^{th} fuses F1 through Fn, the first through nth fuses are cut.

For example, referring to FIG. 4, the first battery cell 31-1, the first fuse F1, the first resistor R1, and the first thermistor resistor Rth1 form a closed circuit. If the first battery cell 31-1 is overheated, the resistance of the first thermistor resistor Rth1, which is an NTC thermistor, decreases. Therefore, a current flowing in the closed circuit including the first battery cell 31-1 increases, and, when the current exceeds a reference value, the first fuse F1 is cut to protect the first battery cell 31-1.

According to an embodiment, if the battery cells 31-1 through 31-n are normal, the sums of resistances of the first through n^{th} resistors R1 through Rn and resistances of the first through n^{th} thermistors Rth1 through Rthn are relatively large values, and thus a closed loop including the battery cells 31-1 through 31-n may operate as an open circuit. For example, if the first battery cell 31-1 is normal, the sum of resistances of the first resistor R1 and the first thermistor Rth1 may be large enough for a closed loop including the first battery cell 31-1 and the first resistor R1 to operate as an open circuit. Of course, as described above, if the first battery cell 31-1 is overheated, the resistance of the first thermistor Rth1 decreases, and thus a current flows in the closed loop, where the first fuse F1 may be blown when the current exceeds a reference value.

Accordingly, when the battery cells 31-1 through 31-n included in the battery 30b according to the present embodiment are overheated, the overheating may be detected and the first through n^{th} fuses F1 through Fn respectively connected to the battery cells 31-1 through 31-n may be cut so that the battery 30b is protected against receiving an overly high current.

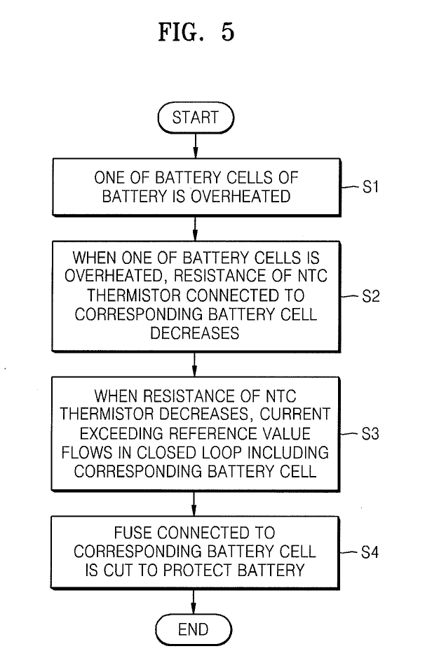

FIG. 5 is a flowchart showing an operation of a battery pack including a battery and a protection circuit according to an embodiment. Depending on the embodiment, additional states may be added, others removed, or the order of the states changes in FIG. 5. In FIG. 5, the term ‘battery cell’ may be replaced with the term ‘battery.’

First, at least one of a plurality of battery cells of the battery is overheated (operation S1). When the at least one battery cell is overheated, the resistance of an NTC thermistor electrically connected to the corresponding battery cell(s) decreases (operation S2). Alternatively, the resistance of an NTC thermistor electrically connected to the entire battery may decrease.

When the resistance of the NTC thermistor decreases, a current exceeding a reference value flows in a closed loop including the corresponding battery cell (operation S3). A fuse connected to the corresponding battery cell is cut to protect the batter (operation S4). According to at least one of the disclosed embodiments, in an energy storage system, when a battery overheats, the resistance of a negative temperature coefficient (NTC) thermistor is changed, and thus amount of a current flowing in a circuit including the battery and a fuse increases. As the amount of the current increases, the fuse blows to protect the battery.

While the above embodiments have been described with reference to the accompanying drawings, it will be understood by those skilled in the art that various changes in form and details may be made therein without departing from the spirit and scope of the invention as defined by the appended claims. The disclosed embodiments should be considered in descriptive sense only and not for purposes of limitation. Therefore, the scope of the invention is defined not by the detailed description but by the appended claims.

What is claimed is:

1. A battery protection apparatus, comprising:
a temperature-dependent resistor electrically connected to at least one battery cell, wherein the temperature-dependent resistor is configured to change internal resistance in a substantially inversely proportional relationship to temperature of one or more of the at least one battery cell; and
a battery protection unit connected between the temperature-dependent resistor and the at least one battery cell, wherein the battery protection unit is configured to block the current flowing through one or more of the at least one battery cell when the current exceeds a first reference value.

2. The apparatus of claim 1, wherein the temperature-dependent resistor is a negative temperature coefficient (NTC) thermistor configured to decrease internal resistance when the battery temperature increases.

3. The apparatus of claim 1, wherein the battery protection unit comprises a fuse.

4. The apparatus of claim 1, wherein the battery protection unit is a single battery protection unit, wherein the temperature-dependent resistor is a single temperature-dependent resistor, and wherein the at least one battery cell comprises a plurality of battery cells connected to the single battery protection unit and the single temperature-dependent resistor.

5. The apparatus of claim 4, wherein the battery cells comprise n battery cells connected in series, wherein n is a positive integer and greater than 1, wherein the battery protection unit is connected to the first of the n battery cells, wherein the temperature-dependent resistor is connected to the nth battery cell, and wherein the battery cells are configured to form a closed-loop with the battery protection unit and the temperature-dependent resistor.

6. The apparatus of claim 1, wherein the battery protection unit comprises a plurality of battery protection units, wherein the temperature-dependent resistor comprises a plurality of temperature-dependent resistors, and wherein the at least one battery cell comprises a plurality of battery cells electrically connected to the battery protection units and the temperature-dependent resistors.

7. The apparatus of claim 6, wherein each of the battery cells comprises first and second terminals, wherein each of the battery protection units is connected to the first terminal of at least one of the battery cells, wherein each of the temperature-dependent resistors is connected to the second terminal of at least one of the battery cells, and wherein at least one of the battery cells is configured to form a closed-loop with at least one of the battery protection units and at least one of the temperature-dependent resistors.

8. The apparatus of claim 1, further comprising at least one resistor connected in series with the temperature-dependent resistor.

9. The apparatus of claim 1, further comprising a battery management system (BMS) electrically connected to the at least one battery cell.

10. The apparatus of claim 9, further comprising a current fuse electrically connected to the battery protection unit and the BMS, wherein the BMS is configured to detect the temperature of the at least one battery cell and blow the current fuse when the detected temperature exceeds a second reference value.

11. The apparatus of claim 9, wherein the battery protection unit is configured to block the current regardless of whether the BMS operates normally or not.

12. The apparatus of claim 1, wherein the battery protection unit is configured to block the current without separately monitoring temperature of the at least one battery cell.

13. A battery protection apparatus, comprising:
a temperature-dependent resistor electrically connected to one end of a plurality of battery cells, wherein the temperature-dependent resistor is configured to change internal resistance based at least in part on temperature of at least one of the battery cells;
a battery protection unit connected between the temperature-dependent resistor and another opposing end of the battery cells, wherein the battery protection unit is configured to block the current flowing through the battery cells when the current exceeds a reference value, and wherein the temperature-dependent resistor and the battery protection unit are electrically connected to each other without having a resistor connected in parallel.

14. The apparatus of claim 13, wherein the temperature-dependent resistor is a negative temperature coefficient (NTC) thermistor configured to decrease internal resistance when the battery temperature increases.

15. The apparatus of claim 13, wherein the battery protection unit is an electrical fuse configured to be blown when current applied thereto exceeds the reference value.

16. The apparatus of claim 13, further comprising a battery management system (BMS) electrically connected to the battery cells

17. An energy storage system, comprising:
a plurality of batteries;
a fuse located adjacent to the batteries;
a plurality of external terminals configured to be connected to a load;
an NTC thermistor electrically connected to at least one of the batteries; and
a resistor connected in series with the NTC thermistor,
wherein the batteries, the fuse and the external terminals form a main current path, and wherein at least one of the batteries, the fuse, the resistor and the NTC thermistor form a battery protection path.

18. The system of claim 17, wherein the fuse comprises a plurality of fuses, wherein the NTC thermistor comprises a plurality of NTC thermistors, and wherein the batteries are electrically connected to the fuses and the NTC thermistors.

19. The system of claim 18, wherein each of the batteries comprises first and second terminals, wherein each of the fuses is connected to the first terminal of at least one of the batteries, wherein each of the NTC thermistors is connected to the second terminal of at least one of the batteries, and wherein at least one of the batteries is configured to form a closed-loop with at least one of the fuses and at least one of the NTC thermistors.

20. The system of claim 17, further comprising a battery management system (BMS) electrically connected to the batteries, wherein the fuse, the NTC thermistor and the resistor are separated from the BMS.
